(19) United States
(12) Patent Application Publication
(10) Pub. No.: US 2007/0104748 A1
(43) Pub. Date: May 10, 2007

(54) DELIVERY SYSTEM FOR CONTINUOUS RELEASE OF VOLATILE SUBSTANCES

(75) Inventors: Birgit Kocherscheidt, Bonefeld (DE); Else Beitzel, Andernach (DE); Hermann-Josef Jaeckels, Bendorf (DE); Michael Roreger, Neuwied (DE)

Correspondence Address: FROMMER LAWRENCE & HAUG, 745 FIFTH AVENUE- 10TH FL., NEW YORK, NY, 10151, US

(73) Assignee: ECS Environment Care Systems GmbH, Andernach (DE)

(21) Appl. No.: 11/552,690

(22) Filed: Oct. 25, 2006

(30) Foreign Application Priority Data
Oct. 29, 2005 (DE) 10 2005 051 892.3

(51) Int. Cl. A01N 25/00

(52) U.S. Cl. 424/405

(57) ABSTRACT

A delivery system for continuous release of fragrances, repellents, attractants, and the like is disclosed. The substance to be released is comprised in a sheetlike polymer matrix. By virtue of the fact that this polymer matrix is in wound form, the substance to be released can be released from the delivery system continuously and over a relatively long time period.

The invention provides a delivery system for the continuous release of volatile substances, especially fragrances, repellents, attractants and/or pheromones, which features a polymer matrix in wound form that comprises the substance(s) to be released.

The prior art includes delivery systems such as the RAK dispenser (sold through Leu+Gygax AG, 5413 Birmenstorf, Switzerland) or the products from the isomate series (sold through Andermatt Biocontrol AG, 6146 Grossdietwil, Switzerland). These are, respectively, plastic ampoules filled with liquid attractants or wires clad with polymers comprising attractants.

A frequent disadvantage of these systems is that the volatile substance is released within a relatively short time period and it is therefore necessary to replace the delivery system by a new one relatively soon after commencement of its application.

It is an object of the invention to provide a delivery system for continuous release of substances that is capable of releasing the substance in question over a relatively long time period and that is easy to produce.

This object is achieved by means of a delivery system which comprises a polymer matrix which comprises the substance to be released and is in wound form in the delivery system. From the delivery system the substance to be released can be released continuously and over a relatively long time period.

In a further embodiment the delivery system may also comprise a support for the polymer matrix, said support being preferably sheetlike and as such being likewise able to be in wound form.

Further constituents of the delivery system may be a core and/or a fastening means.

The core may be a rotatable body which is preferably cylindrical and around which the polymer matrix is wound. The material of such a body may comprise, for example, metals, plastics, and natural materials. These bodies are preferably in the form of a rod or wire. In one particular embodiment the rotatable body may extend on at least one side beyond the width of the polymer matrix and may be bent in the form of a hook at its end. In this embodiment the rotatable body is able not only to form the core of the winding but also to act at the same time as the fastening means.

As fastening means it is, however, also possible, besides this embodiment of a core ending in the form of a hook, to use other means as well, examples being struts which run around the winding, or baskets into which the delivery system is inserted and which in turn are provided again, preferably, with hooks. The fixing means is equipped in such a way that it can be fastened—preferably with a single movement—reliably, i.e., impact-resistantly, to the target object (a grapevine or the branch of a fruit tree, for example).

The delivery system possesses a height which corresponds at least to the width of the support, plus where appropriate that of the protruding part of any fixing means present. Preferably the delivery system is up to 20 high, more preferably 3 to 10 cm. The diameter of the delivery system depends essentially on the thickness of the polymer matrix and on the number of winds. It is preferably between 0.5 and 5 cm, more preferably between 1 and 2 cm.

Suitable packaging for the delivery system includes, preferably, containers which are impervious to the substance to be released. These include, for example, tube pouches manufactured from a material, such as Surlyn, which is impervious to the substance to be released.

The polymer matrix is constructed from materials capable of taking up the substance to be released and of releasing it again. Suitable materials are natural and synthetic polymers, the synthetic polymers being preferred.

The natural polymers include polysaccharides such as starch, chitin, pectins, cellulose, hemicelluloses, etc., polypeptides such as keratins, gelatin, collagen, proteins, etc., and polyprenes such as natural rubber.

The synthetic polymers include chemically modified derivatives of these aforementioned natural polymers, i.e., modified natural materials.

The synthetic polymers further include those preparable by polycondensation, addition polymerization or polyaddition of suitable monomers. The polycondensates include polyamides, polycarbonates, polyesters, and polyvinylacetals. The addition polymers include polyethylenes, polypropylenes, poly-1-butenes, poly-4-methyl-1-pentenes, polyvinyl chlorides, poly(meth)-acrylates, polyacrylonitriles, polystyrenes, polyacetals, fluoropolymers, polyvinyl alcohols, and polyvinyl acetates. The polyadducts include polyurethanes. Within the group of the synthetic polymers the thermo-plastics are a particularly preferred group of suitable materials for the polymer matrix.

Particular preference is given to using rubber, triblock polymers (e.g., polystyrene block copolymers such as Kraton G, for example), polyurethanes, ethylene-vinylacetate copolymers (e.g., Evatane 40-55), polyacrylates (for example, solvent-based polyacrylates such as Durotak 380-2954, or polyacrylates available commercially as solids, such as Durotak H 312), poly-amides, polyisobutenes (for example, those with a molar mass of between 40 000 and 120 000 g/mol and those with a molar mass of between 300 000 and 2 500 000 g/mol, and mixtures thereof), polyvinyl alcohols, and polyvinyl acetates as material for the polymer matrix. Besides the natural and/or synthetic polymer(s), the polymer matrix may further comprise soft resins, hard resins and/or auxiliaries. Auxiliaries which may be used include cellulose derivatives, sunblockers, reflectors, thickeners, fillers, plasticizers, tackifiers, cohesion enhancers, dyes, pigments, etc.

The total amount of the auxiliaries may be up to 50% by weight, preferably up to 30% by weight of the polymer matrix.

The soft resins serve essentially to set a certain tack, which can contribute to ensuring the structural integrity of the polymer matrix and hence to preventing the winding unrolling. The term “soft resin” comprehends natural resins or synthetic resins which are liquid at standard temperature. They may dry to a solid film or remain tacky as a film. The nondrying soft resins may also be classed as plasticizers. In chemical terms they are medium to high molecular mass polyolefins, polyesters, polyethers, polyacrylates or amino resins. On account of their properties and functions in application, some of them are also referred to as oligomeric or polymeric plasticizers or as plasticizer resins.

Depending on the material selected for the polymer matrix, the amount of soft resin can be between 0 and 50% by weight, preferably between 20% and 40% by weight. The preferred soft resins include products, such as terpene-phenolic resins for example, which are obtainable under the brand name Dertophene, or hydroabietyl alcohol resins, which are available under the brand name Abitol.

The hard resins include not only rosin and its derivatives but also higher-melting reaction products of resin acids, i.e., resin esters, and also the addition products of rosin and maleic anhydride (maleate resins), the resin-modified phenolic resins referred to as synthetic copals, and the aldehydic and ketonic resins. An example of a preferred hard resin is Herculin C. The amount of hard resins can be between 0 and 20% by weight.

In one particular embodiment the polymer matrix may be adhesively treated, and in particular may be pressure-sensitively adhesively treated. By “adhesive” is meant here the property whereby there occurs, between the surface of the polymer matrix and a substrate, an adhesion effect governed by mechanical connection, diffusion in the transition zone, adsorption, electrostatic forces, van-der-Waals' forces, or by chemical bonding. By “pressure-sensitively adhesive” is meant that the adhesive property is retained in the solvent-free state at 20° C., so that the polymer matrix is permanently adhesive and remains capable of adhesion. In the “pressure-sensitively adhesively” equipped state, the polymer matrix can be adhered under gentle applied pressure to virtually any substrates and can also be removed from them again substantially without residue. In general the tack of the polymer matrix can be adjusted through the selection of appropriate soft and/or hard resins and their proportion in the polymer matrix.

The polymer matrix may be colorless or colored. It may also be transparent or opaque.

The polymer matrix may be sheetlike and may be present in different layer thicknesses, but preferably with a constant layer thickness. It may be between about 25 μm and 1 mm thick. Preferably the polymer matrix has a layer thickness of between 100 and 500 μm.

The length of the polymer matrix in a specific delivery system may depend on a variety of factors, examples being the amount of the substance to be released and the desired release rate, the width of the polymer matrix (a), and the handiness of the delivery system. For technical reasons a length of 1 cm is regarded as a lower limit. As a technically rational upper length limit, a figure of about 200 m may be set. Preferred length ranges lie between 5 cm and 50 m, preferably between 20 cm and 5 m.

The width of the polymer matrix (a) may be above 2 mm. The upper limit on the width depends on the wieldiness of the delivery system and ought not to be above 50 cm. Preferred widths are between 5 mm and 40 cm, more preferably between 2 cm and 40 cm.

Suitable supports include materials which may be present in a flat form. Suitable materials are nonwovens (e.g., of polyethylene, polyethylene terephthalate, polypropylene, viscose and/or blends thereof), metal foils (e.g., of aluminum), polyethylene (PE), oriented polypropylene (OPP), polypropylene (PP), polyurethane (PU), paper, foams (e.g., open-celled, closed-celled foams, etc., comprising framework substances such as polystyrene, polyurethane, polyvinyl chloride, etc.), glass fibers, and textile materials, and also combinations or composite materials thereof.

The function of the support—where such is present—is to support the polymer matrix located on it and thus to provide it with additional hold. Consequently the support is preferably in the form of a foil or film, alternatively, where appropriate, in the form of a composite laminate. In connection with the production of the delivery system the support may also serve as the substrate sheet to be coated, to which a composition comprising at least the polymer material of the polymer matrix and the substance to be released is applied.

The support material may be free from the substance to be released. Alternatively and preferably it may also be permeable to the substance to be released. In this embodiment the support may also control the rate of diffusion of the substance to be released on the way from “winds near to the core” to the outer top face (i.e., the external face of the last wind) of the delivery system. With these properties the support acts as a membrane. In one particular embodiment the support may be printed.

In one particular embodiment the support covers the polymer matrix on one side over the full area, with support and polymer matrix forming a composite laminate or at least a constituent thereof. In this case the length and width of the support are identical with the respective length and the respective width of the polymer matrix. However, the support may also have a width (b) which is different from the width of the polymer matrix (a). Preferably the width of the support (b) is greater than that of the polymer matrix, in order, for example, for the matrix to be better protected from external physical or mechanical influences.

The support may, however, also have a substantially shorter length, if, for example, it does not cover the polymer matrix over the full area. Thus in one particular embodiment the support may envelop the polymer matrix, which in wound form, only once and in this way may represent in practice the “last finishing ply” of a sheet around the polymer matrix.

Suitable supports comprise preferably commercially available plastics (of polyethylene, polypropylene, polyurethane, polystyrene, etc., for example) and cellulose and derivatives thereof, and also combinations of these. The support may be in the form of a film or foil, a nonwoven layer, a composite laminate, a solid foam layer, etc. One preferred embodiment is a polyethylene- and/or polypropylene-coated paper.

The layer thickness of the support can be between 40 and 100 μm, preferably between 50 and 70 μm.

Suitable substances for release that can be used for the delivery system include, preferably, volatile substances. These include, in particular, attractants, repellents, and fragrances, and also combinations of these. The attractants include, in particular, sex attractants (pheromones) and feeding attractants. The repellents include agents for deterring insects and arachnids (insect repellents) and feeding inhibitors. The insect repellents include essential oils such as anise oil, bergamot oil, birch tar, camphor, citronella oil, eucalyptus oil, geranium oil, pine oils, coconut oil, lavender oil, nutmeg oil, clove oil, orange blossom oil, peppermint oil, oils of pennyroyal (pennyroyal oil), pyrethrum, thyme oil, and cinnamon oil. Synthetic repellents are known as well, such as N,N-diethyl-m-toluamide, dimethyl carbamate, 2-ethyl-1,3-hexanediol, N,N-diethyloctanamide, 2-(octylthio)ethanol, and ethyl 3-(N-acetyl-N-butylamino)propionate, for example. Fragrances include the synthetic odorants and essential oils known to the skilled worker. As a substance for release it is also possible to employ the combination of at least two attractants, at least two repellents or at least two fragrances.

The amount of the substance to be released in the polymer matrix may depend on the desired release duration, the geometric properties of the delivery system, the physicochemical properties of the material from which the polymer matrix is constructed, the physiological action of the substance to be released, etc. The amount of the substance to be released is typically between 0.001% and 60% by weight, preferably between 0.1% and 35% by weight.

Particularly preferred substances for release are (Z)-9-dodecenyl acetate, dodecyl acetate, octadecyl acetate, (E,Z)-7,9-dodecadienyl acetate, (E,E)-8,10-dodecadien-1-ol, dodecan-1-ol, tetradecen-1-ol, and mixtures thereo; and especially those which can be used as specific pheromones for Eupoecilia ambiguella and Lobesia botrana.

The term “substance to be released” for the purposes of this description also includes, of course, the combination of two or more substances which meet the stated criteria. The substance to be released is at least partly in solution in the polymer matrix. Undissolved constituents of the substance to be released are preferably in suspended form in the polymer matrix.

The term “in wound form” means that the polymer matrix in the sheetlike state is subjected to a process step referred to as “winding” and as a result is then present as a wound roll. Viewed externally, this polymer matrix forms a cylinder having a defined height (resulting from the width of the sheetlike polymer matrix employed) and a defined diameter (dependent on the layer thickness of the polymer matrix and on the number of winds). The number of winds of the polymer matrix in wound form is in theory not subject to any upward limit; at the downward end, the minimum number of winds is 1, corresponding to a twin-ply polymer matrix. In practice the upper limit on the winds is not greater than 2000. The number of winds is preferably between 10 and 500.

The term “continuous release” means that, following “activation” (i.e., after the delivery system has been unpacked from its packaging), the substance to be released is delivered from the delivery system to the environment without temporal interruption. The release of the substance to be released may last over a relatively long time period of at least 1 day. Preferably, however, the release lasts for at least a week or even longer. In one preferred embodiment the delivery system is capable of delivering the substance to be released over a time period of at least one month.

Influencing variables on the delivery rate are the thickness of the polymer matrix, the amount (loading of substance to be released in the polymer matrix), the possible presence of a support which acts as a membrane, the permeability of the support to the substance to be released, and the number of winds (i.e., number of plies). For regulation of delivery the delivery system may also be composed of a plurality of versions as described above (e.g., internally thickly coated PP film, externally thinly coated nonwoven).

The substance to be released is released by being delivered from the surface and the edges of the polymer matrix in wound form into the environment. The “surface” in question here is of course only the section of the polymer matrix that represents the “last wind” and is in contact with the environment. The section of the polymer matrix in wound form that is located beneath this last wind has no contact with the environment. This section, instead, is masked in each case by a successive wind. On its path from a specific section of the polymer matrix into the environment, therefore, the substance to be released must first penetrate the section of the polymer matrix that represents respectively the next wind.

One alternative consists in what is called “edge release”. In this case the substance to be released migrates within the polymer matrix into a volume unit at the margin of the polymer matrix in wound form, from where it is delivered into the environment. This nature of release is enforced when using a support which is impermeable to the substance to be released.

The delivery system is generally produced by mixing the materials that form the polymer matrix with the substance to be released, together where appropriate with further auxiliaries, and, where appropriate, with use of suitable solvents and/or application of heat. The resultant composition is applied in fluid form to a substrate and spread out to form a sheetlike intermediate. The substrate may be a sheetlike material which is described here at a later point in time, or, preferably, may be the component which functions as a support in the delivery system. After the composition has been applied it is, where appropriate, dried and/or freed from any solvent present. This produces the polymer matrix in sheet form on the substrate/support. The substrate can then be removed, where appropriate, from the sheetlike polymer matrix. In each case the sheetlike polymer matrix (with or without support) is introduced into a winding means. Winding takes place preferably by placement of a cylindrical body onto the sheetlike polymer matrix, perpendicular to its lengthwise direction. The actual winding takes place by rotation of the cylindrical body and transporting of the sheetlike polymer matrix. When the desired number of rotations has been performed, the product is singularized by transverse cutting. The polymer matrix, which is now in wound form, is then transported into suitable packaging and sealed therein.

The examples below serve to illustrate the invention.

### EXAMPLE 1

### Delivery System in the Form of a Pheromone Dispenser

A delivery system which can be used in viticulture as a pheromone dispenser to confuse the grape berry moth is produced by the general process. The support used is a PP nonwoven which has been vapor-coated with aluminum on one side and has a width of 40 mm and a length of 3 m. The polymer matrix contains 95% by weight of Durotak H 312 (a commercial hotmelt adhesive) and 5% by weight of a pheromone (E,Z)-7,9-dodecadienyl acetate. The coating width is likewise 40 mm, with a coatweight of 200 g/m². The polymer matrix is wound around a hanging means (hook).

This delivery system contains 1.2 g of the pheromone to be delivered.

### EXAMPLE 2

### Delivery System in the Form of a Fragrance Dispenser

A delivery system is produced as a fragrance dispenser for room fragrancing. The support used is a viscose nonwoven having a thickness of 300 g/m² a width of 100 mm, and a length of 20 m. The polymer matrix is composed of 75% by weight of an EVA copolymer adhesive formulation (Evathane 40-55) and 25% by weight of citrus oil. The coating width is 120 mm and the coatweight of the polymer matrix is 200 g/M². The composite of the polymer matrix and support is wound around a cardboard tube.

This delivery system contains 10 g of citrus oil to be delivered.

### EXAMPLE 3

### Delivery System in the Form of an Attractant Dispenser

A delivery system is produced as an attractant dispenser for use in insect traps. The support used is a PE film (thickness 30 g/m², width 10 mm, length about 2.5 m). The polymer matrix is composed of 99% by weight of a commercial hotmelt adhesive (Durotak 380-2954) and 1% by weight of “Wein FK” (an attractant mixture from Symrise), which is applied to the support with a coating width of 10 mm and a coatweight of 70 g/m². The system is wound around a plastic tube.

This delivery system contains 0.175 g of attractant to be delivered.

The figures serve to illustrate the invention.

FIG. 1 shows a delivery system comprising polymer matrix with support, the support having a width (b) which is greater than the width (a) of the polymer matrix.

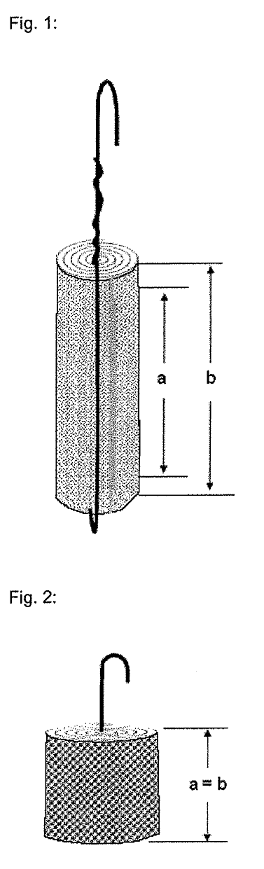

FIG. 2 shows a delivery system comprising polymer matrix with support, the support possessing the same width as the polymer matrix, i.e., (a)=(b).

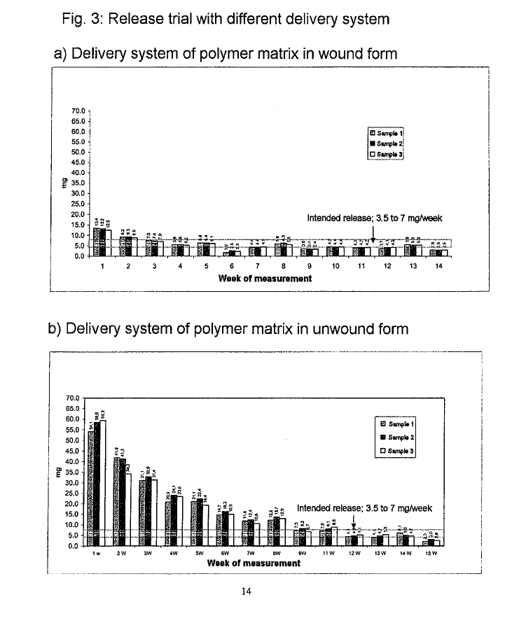

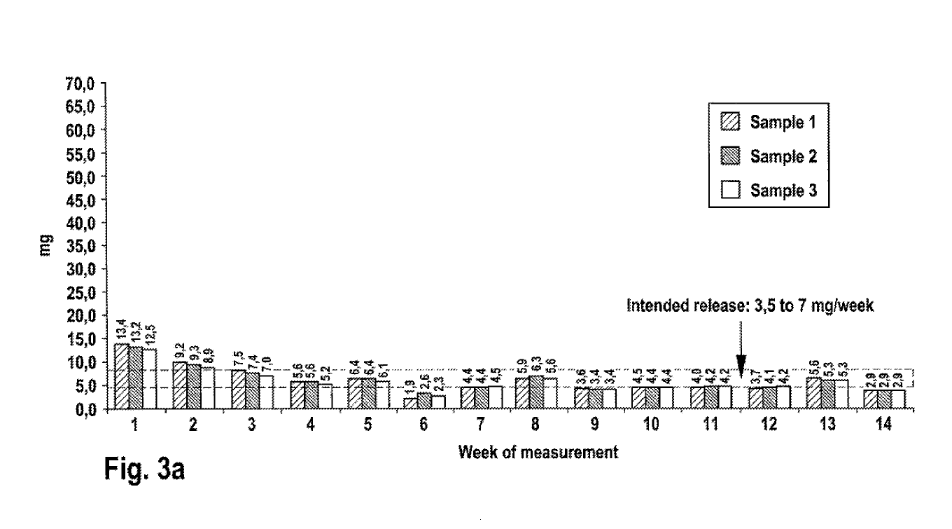

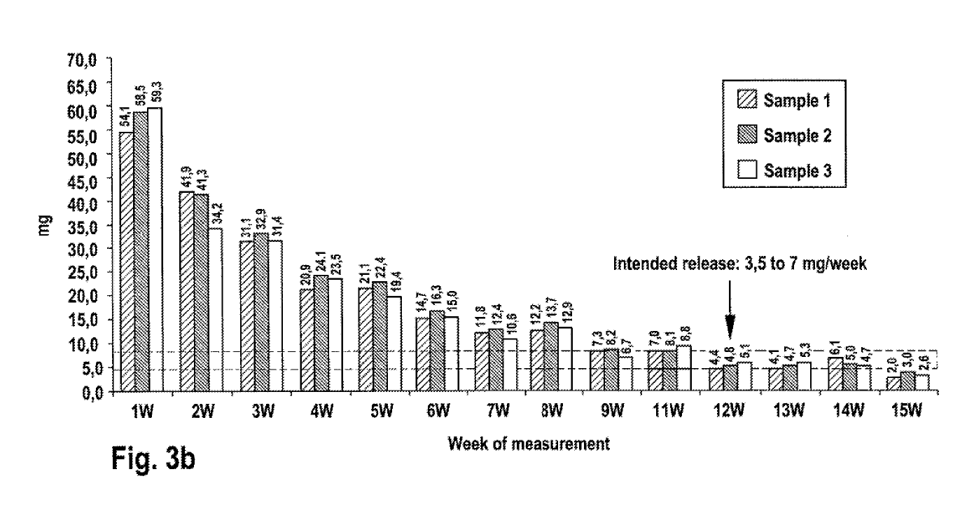

FIG. 3 shows results of the release trials. The top diagram a) shows the release of the pheromone (E,Z)-7,9-dodecadienyl acetate over the course of 14 weeks from delivery systems having a polymer matrix in wound form. The bottom diagram b) shows the release of the same pheromone from a corresponding delivery system having a flat, unwound polymer matrix. The arrow marks the region of “intended release” of 3.5 to 7 mg/week. It can be seen that, with the delivery system having the polymer matrix in wound form (a), this range is attained in the time between week 3 to 13. The delivery system with the flat, unwound polymer matrix (b) attains this range in the time between week 9 and 14. This means that the wound form of the polymer matrix attains the intended release over a substantially longer time period and, in particular in the first weeks, does not exhibit the disproportionately vigorous release of pheromone of the unwound embodiment.

1. A delivery system for continuous release of a substance to be released, comprising a polymer matrix which comprises the substance to be released and which is in wound form.

2. The delivery system as claimed in claim 1, wherein the polymer matrix comprises at least one natural and/or synthetic polymer.

3. The delivery system as claimed in claim 1, wherein the polymer matrix comprises a synthetic polymer which is thermoplastic.

4. The delivery system as claimed in claim 1, wherein the polymer matrix possesses a width of between 2 mm and 50 cm, preferably between 2 cm and 40 cm.

5. The delivery system as claimed in claim 1, wherein the polymer matrix possesses a length of less than 200 m, preferably between 5 cm and 20 m, and more preferably between 20 cm and 5 m.

6. The delivery system as claimed in claim 1, wherein the substance to be released comprises at least one attractant, repellent, fragrance or a combination thereof.

7. The delivery system as claimed in claim 1, wherein the amount of the substance to be released in the polymer matrix is between 0.001% to 60% by weight, preferably between 0.1% and 35% by weight.

8. The delivery system as claimed in claim 1, wherein the polymer matrix in wound form has between 1 and 2000, preferably between 10 and 500 winds.

9. The delivery system as claimed in claim 1, further comprising a flat support in wound form.

10. The delivery system as claimed in claim 9, wherein the support covers the polymer matrix on one side over the whole area.

11. The delivery system as claimed in claim 9, wherein the support possesses a width (b) greater than the width (a) of the polymer matrix.

12. A process for producing a delivery system comprising a polymer matrix which is in wound form and comprises a substance to be released, comprising the steps of
producing a mixture of a natural and/or synthetic polymer and at least one substance to be released,
applying the mixture to a sheetlike substrate,
transforming the mixture into a polymer matrix comprising a substance to be released,
winding the polymer matrix, and
singularizing.

13. The process as claimed in claim 12, wherein the sheetlike substrate is removed from the polymer matrix before said matrix is wound.

14. The process as claimed in claim 12, wherein the sheetlike substrate is the flat support of the delivery system.

15. The process as claimed in claim 12, wherein after the winding operation a flat support is rolled around the polymer matrix which is in wound form.

16. The use of a delivery system comprising a polymer matrix which is in wound form and comprises a substance to be released as a fragrance dispenser, as a pheromone dispenser or as an attractant dispenser.
